(19) United States
(12) Patent Application Publication
(10) Pub. No.: US 2012/0047723 A1
(43) Pub. Date: Mar. 1, 2012

(54) Actuator tool

(76) Inventor: Christopher Fred Roach, (US)

(21) Appl. No.: 13/136,595

(22) Filed: Aug. 5, 2011

Related U.S. Application Data
(60) Provisional application No. 61/402,213, filed on Aug. 26, 2010.

(51) Int. Cl. B23P 19/00

(52) U.S. Cl. 29/700

(57) ABSTRACT

The Actuator Tool is designed to allow easy removal of saucer-shaped irrigation flow control devices known by many names such as irrigation actuators, automatic adapters, automators, etc., that are part of an irrigation valve assembly. The Actuator Tool has a unique design allowing it to circumvent the saucer-shaped diaphragm housing to allow easy access to said irrigation actuators' said grip point when the irrigation valve assembly is obstructed by a tree, wall, irrigation valve box, etc., or in cases where the irrigation valve assemblies have been installed too close together to allow access to the said actuators' hexagonal square or similar shaped said grip point. The preferred configuration is “U” shaped with a jaw on either end, two holes to accommodate a ½″ drive breaker bar as a handle on both ends, and two flat areas to allow the use of a pipe wrench as a handle.

### CROSS-REFERENCE TO RELATED APPLICATIONS

This application claims priority to U.S. Provisional Patent Application No. 61/402,213, filed on Aug. 26, 2010 the entire contents are incorporated herein by reference and should be considered a part of this specification.

### TECHNICAL FIELD

This invention applies to the irrigation industry as well as the plumbing industry.

### DESCRIPTION

The Actuator Tool 111, best seen in FIG. 1, allows the easy removal and installation of actuators with saucer or disc-shaped diaphragm housings. The said actuators 250 are best seen in FIGS. 2 and 3. These flow control devices, commonly called actuators, 250 are the component that allows a irrigation timer via two electrical conductors or wires 230 FIG. 9 in unison with an attached solenoid 240 FIG. 9 to control liquid flow in an irrigation valve assembly 190 FIG. 9. Actuators 250 FIGS. 2 and 3 are normally made of metal or plastic and have many names such as manual irrigation valve adaptors/electric irrigation valve actuators/irrigation automatons/irrigation automatic adaptors/irrigation electric adaptors/classic brass irrigation valve adapters/irrigation timer adaptors/irrigation valve adaptors and so on. Most are significantly similar in design and best illustrated by 250 FIGS. 2 and 3. Said actuators 250 are used to control liquid flow as part of a irrigation valve assembly 190 FIG. 9. The Actuator Tool 111 best seen in FIG. 1 allows the easy removal and installation of actuators 250 from an irrigation valve assembly 190 FIG. 9 in areas where clearance is a problem such as when a tree, wall or other object has been added too close to the irrigation valve actuator assembly 190 FIG. 9 or the irrigation valve actuator assemblies 190 FIG. 9 have been grouped too close too each other.

The Actuator Tool 111 best seen in FIG. 1 is designed to allow the worker to easily access the actuator's 250 hexagonal square or similar shaped said grip point 100 best seen in FIGS. 2 and 3.

The Actuator Tool 111 FIG. 1 is designed with an offset jaw 10 that is designed to circumvent the actuator's 250 FIGS. 2 and 3 solenoid 240 and/or wide circular or saucer-shaped or disc-shaped diaphragm housing 80 best seen in FIGS. 2 and 3, that restricts access to the actuator's 250 FIGS. 2 and 3 said hexagonal square or similar shaped grip point 100 best seen in FIGS. 2 and 3.

The Actuator Tool 111 best seen in FIG. 1 has jaws 10 that may be non-standard sizes, neither American standard IE: SAE sizes (as defined by the Society of Automotive Engineers) or metric sizes such as 10 mm, 11 mm, 12 mm, etc. The jaws 10 may be standard SAE sizes (as defined by the Society of Automotive Engineers) such as ½″, 9/16″, ⅞″ and or metric sizes such as 10 mm, 11 mm, 12 mm, etc. Typically the Actuator Tool 111 shown in FIG. 1 will have a standard size jaw 10 (as defined by the Society of Automotive Engineers) such as ½″, 9/16″, ⅞″ and or metric sizes such as 10 mm, 11 mm, 12 mm, etc. on one end and a non-standard size jaw 10 such as 0.940″ to best fit the irregular sized actuator said grip points 100 best seen in FIGS. 2 and 3, thereby allowing proper fitting of the jaws 10 to any hexagonal square or similar shaped grip point 100 that may have irregular casting and/or molding residues and/or embossed reference markings 120 best seen in FIG. 2. (At times, due to the nature of these various irregularities, both jaws 10 of the Actuator Tool FIG. 1 must be used alternately.)

The Actuator Tool 111 in it's preferred configuration may have a ½″ square hole 20 best seen in FIG. 1 in both ends, perpendicular to the jaws 10, to allow attachment of a leverage device such as a ratchet wrench 130 FIG. 4, breaker bar 140 FIG. 5; or a ½″ extension 150 FIG. 6 may be used with the breaker bar or ratchet in combination to provide the user a more convenient or safe working posture. The leverage tool should be inserted into the square hole 20 from the outside surface of the wrench, opposite the jaw 10 contacting the said hexagonal square or similar shaped said grip point 100 as seen in FIG. 4. To allow an alternative leverage device, there is a centrally located round approximately 0.85″ hole 60 designed for a ½″ galvanized pipe bar or similar object 62 to be inserted as a leverage device or handle as seen in FIG. 8. In addition, a pipe wrench 160 FIG. 7 may be used as a handle by gripping the Actuator Tool beyond the approximately 0.85″ hole 60 on the approximately 2″ wide flat area 50, opposite the jaw 10 contacting the hexagonal square or similar shaped said grip point 100 best seen in FIG. 10.

### A BRIEF DESCRIPTION OF THE DRAWINGS

FIG. 1: The Actuator Tool.

FIG. 2: An actuator.

FIG. 3: Another example of an actuator.

FIG. 4: A ½″ drive ratchet with the Actuator Tool.

FIG. 5: A ½″ drive breaker bar connected to the Actuator Tool.

FIG. 6: A ½″ drive breaker bar with a ½″ drive extension and the Actuator Tool.

FIG. 7: A pipe wrench gripping the Actuator Tool.

FIG. 8: A ½″ pipe or bar and the Actuator Tool.

FIG. 9: An irrigation valve assembly.

FIG. 10: An irrigation valve assembly with the Actuator Tool gripping the actuator.

FIG. 11: An irrigation valve assembly with a manual valve stem installed.

### DETAILED DESCRIPTION OF PREFERRED EMBODIMENTS

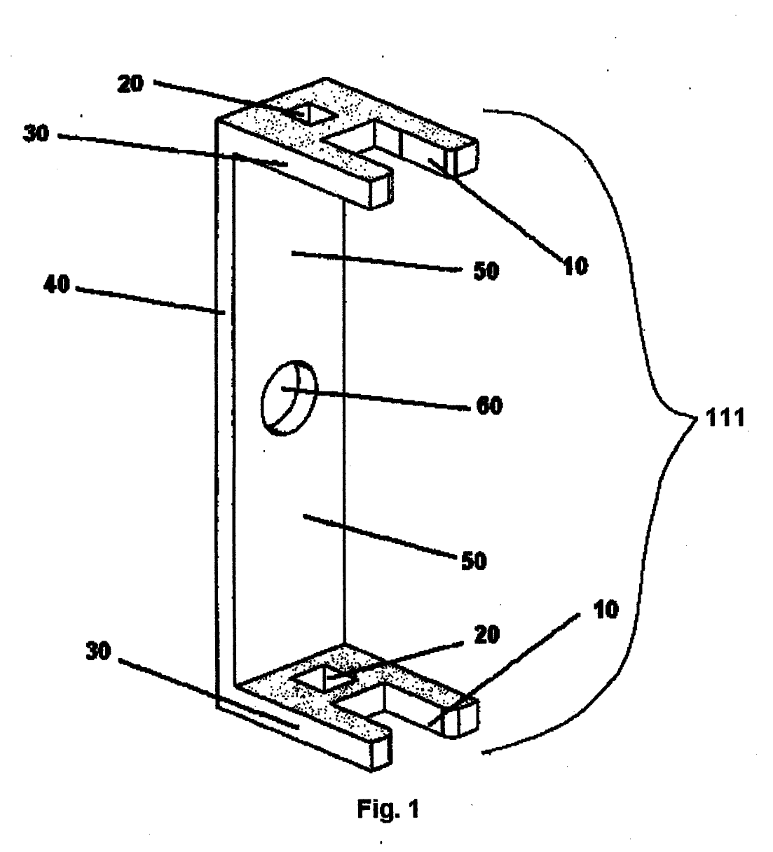

FIG. 1 shows a perspective view of the Actuator Tool 111 in it's preferred configuration. This is one embodiment of the present invention and is not intended to limit the scope of the present invention. This preferred configuration may be constructed of any hard material such as plastic or metal. The preferred material is steel. The Actuator Tool is made by cutting out the unique precise shapes with a computer guided laser cutter or C.N.C laser cutter from a ¼″ thick sheet of steel, and then bending each end with a hydraulic bender at a 90 degree angle, 2½ inches in from each end. The tools are then sanded and a finish such as black paint is applied. The tool may be any color, preferably black, and any size, preferably 8½″ long, 2″ wide, ¼″ thick, with 2½″ protruding horizontal bars 30. The preferred configuration of the Actuator Tool has two opposing jaws 10. One end is 0.94″ wide and 0.883″ deep, and ¼″ thick (a non standard size). The other end is a standard ⅞″ wide and 0.833″ deep and ¼″ thick located on the two horizontal bars 30. Two opposing approximately ½″ square holes 20 also located on the two opposing horizontal bars 30; the two opposing horizontal bars 30; one vertical bar 40; two opposing flat areas 50 located on vertical bar 40; one approximately 0.85″ round hole 60 centrally located on the vertical bar 40.

The jaws 10 may be any size and shape. Preferably they are between 0.5″ and 1.5″ wide, and more preferably between 0.866″ and 1.01″ wide and U-shaped. The jaws 10 may be non-standard sizes, neither American standard IE: SAE sizes (as defined by the Society of Automotive Engineers) or metric sizes such as 10 mm, 11 mm, 12 mm, etc. The jaws 10 may be standard SAE sizes (as defined by the Society of Automotive Engineers) and/or metric sizes such as 10 mm, 11 mm, 12 mm, etc. Typically in the preferred configuration, the Actuator

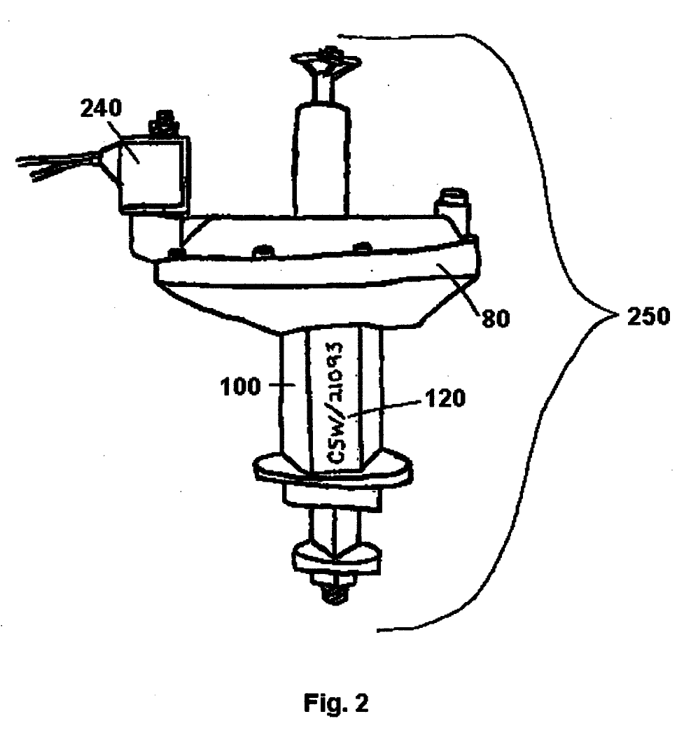

The Actuator Tool 111 shown in FIG. 1 will have a standard size jaw 10 (as defined by the Society of Automotive Engineers) and/or metric sizes such as 10 mm, 11 mm, 12 mm, etc. on one end, and a non-standard size jaw 10 such as 0.940″ to best fit the irregular-sized actuator, said grip points 100 best seen in FIG. 2. These said grip points 100 may be irregular in size due to common embossed markings 120 or irregular and/or blemished castings, typical of the actuator manufacturing process. The jaws 10 may be any depth, preferably between ½″ and 1½″, and more preferably between ¾″ and 1″ deep, the preferred depth of the jaws 10 is 0.883″.

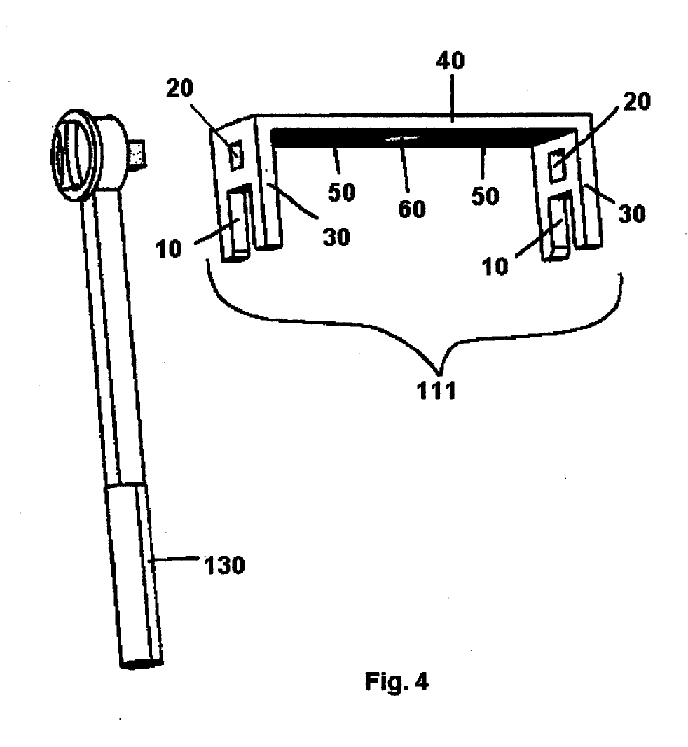

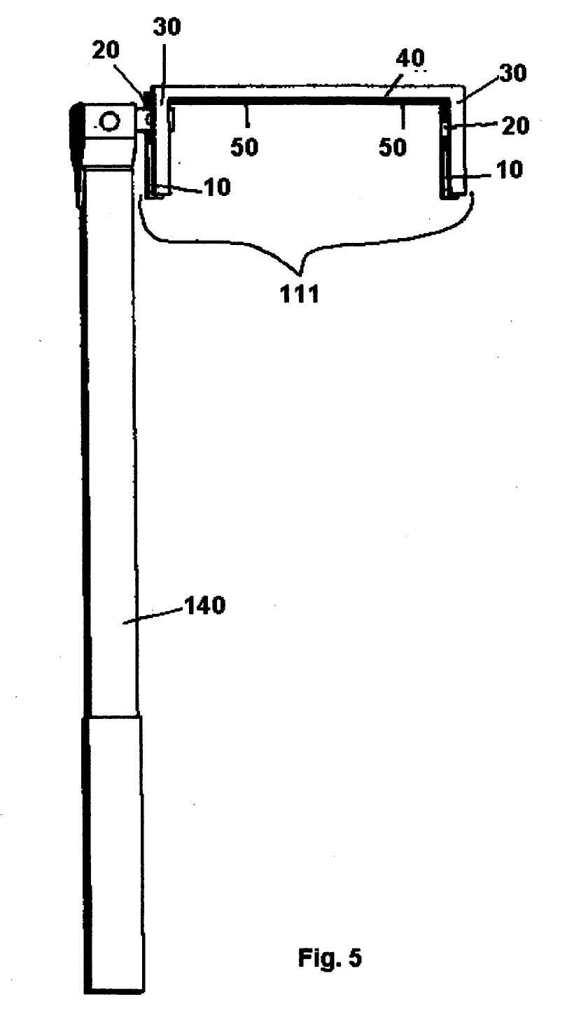

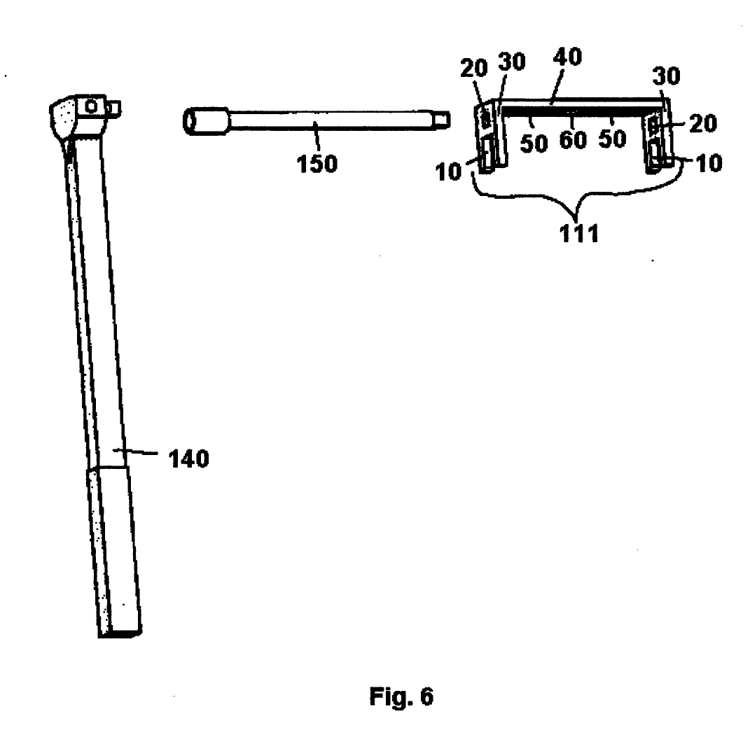

The two opposing square holes 20 may be any size, preferably between ¼″ and 1″, and more preferably between ⅜″ and ¾″. The preferred size is ½″. They are located on the two opposing horizontal bars 30 and are designed to receive a ½″ drive ratchet 130 best seen in FIG. 4, or a ½″ breaker bar 140 best seen in FIG. 5, as a handle or leverage device. An extension 150 best seen in FIG. 6 may be used in combination to provide the operator a more convenient and/or safe working posture.

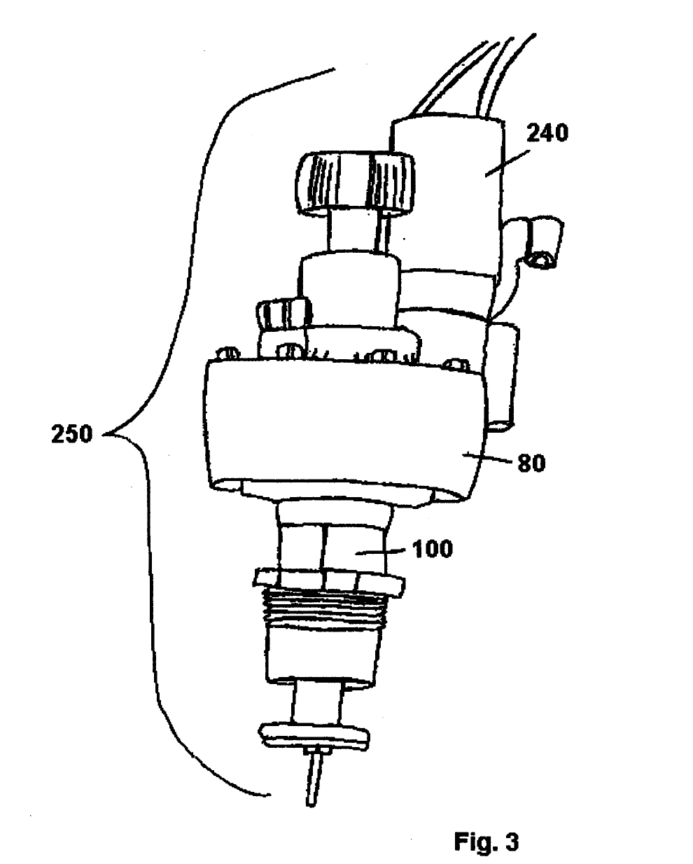

The two opposing horizontal bars 30 are preferably 2½″×2″×¼″. They are designed in conjunction with the vertical bar 40 to circumvent the wide circular and/or saucer-shaped and/or disc-shaped diaphragm, or similar housing 80 best seen in FIG. 2 and FIG. 3, that may restrict access to the actuator's 250 said gripping area 100 best seen in FIG. 2.

The vertical bar, 40 preferably 8½″×2″×¼″, provides reach in the circumventing of the actuator's 250 solenoid 240, FIG. 2 and FIG. 3 and/or wide circular and/or saucer-shaped and/or disc-shaped diaphragm or similar housing 80 best seen in FIG. 2 and FIG. 3, that may restrict access to the actuator's 250 said gripping area 100 best seen in FIG. 2.

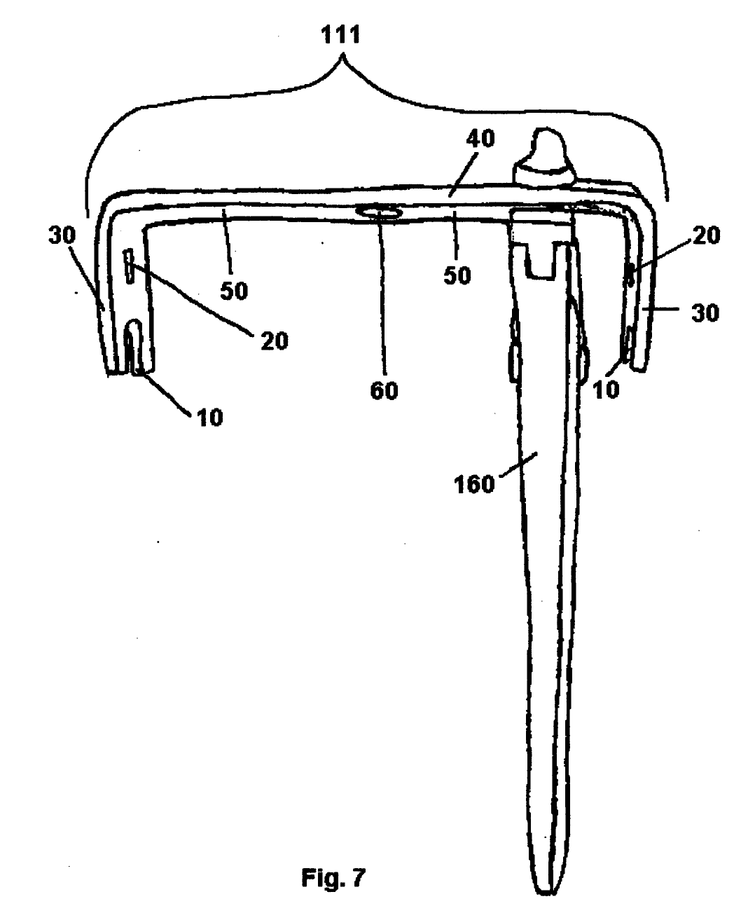

The two opposing flat areas 50 are preferably 3½″×2″×¼″. They provide a grip point for a pipe wrench 160 to be used as a handle as seen in FIG. 7.

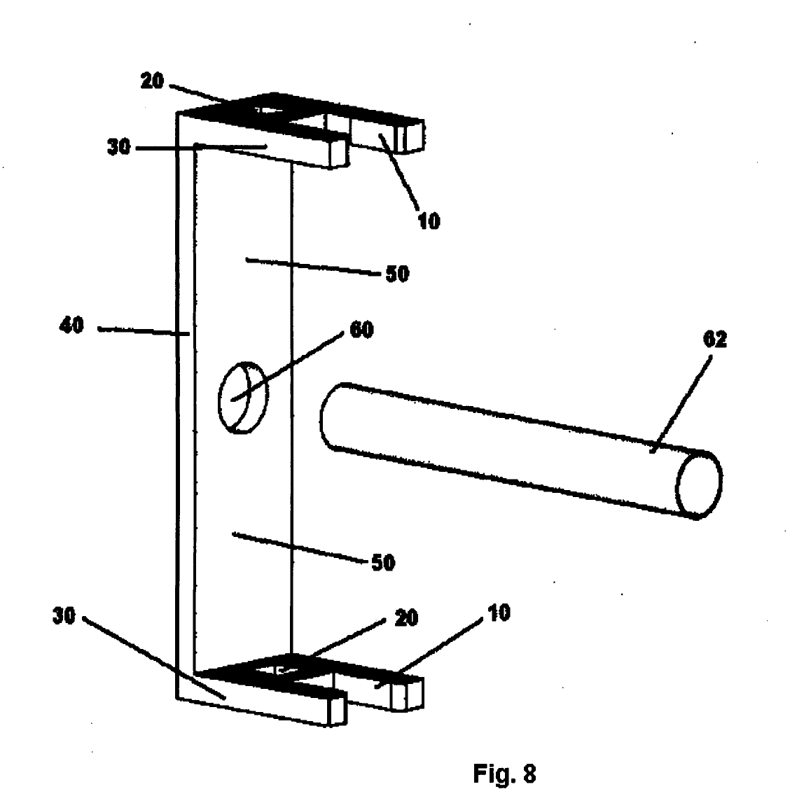

In the preferred configuration, there is a centrally located hole 60 that may be any size or shape. The preferred shape of the hole is round. Preferably the hole is between ½′ and 2″, more preferably between ¾″ and 1½″. The preferred size is 0.85″. The hole 60 is designed to receive a ½″ steel pipe or round bar 62 FIG. 8 to be used as an alternate handle.

### The Unique Aspects of this Invention

There are several unique aspects to the invention of the Actuator Tool such as the use of a non-standard size jaw such as 0.940″ on one end, neither American standard IE: SAE sizes (as defined by the Society of Automotive Engineers) or metric sizes such as 10 mm, 11 mm, 12 mm, etc., designed to best fit the irregular sized actuator said grip points 100 best seen in FIG. 2. These said grip points 100 that may be irregular in size due to common embossed markings 120 also seen in FIG. 2 or irregular and/or blemished castings typical of the actuator manufacturing process.

The unique shape that circumvents an actuator's diagram housing 80 seen in FIGS. 2, 3, 9 and 10 provide easy assess to the said grip points 100 also seen in FIGS. 2, 3, 9 and 10.

The ability to use multiple types of leverage devices as a handle, such as a pipe wrench, or a ½″ breaker bar, or similar device, or when a huge amount of leverage is needed, a long piece of ½″ steel pipe can be used. This ability to supply one's own handle will reduce the final price of the Actuator Tool and save space in the purchaser's tool box since someone purchasing this tool may already have a piece of pipe, pipe wrench or other device this tool can accommodate to use as a handle.

A tool designed to specifically remove and install removable saucer-shaped irrigation actuators is unique.

### INDUSTRIAL APPLICABILITY

This invention applies to the irrigation industry as well as the plumbing industry.

### AN EXAMPLE OF USE

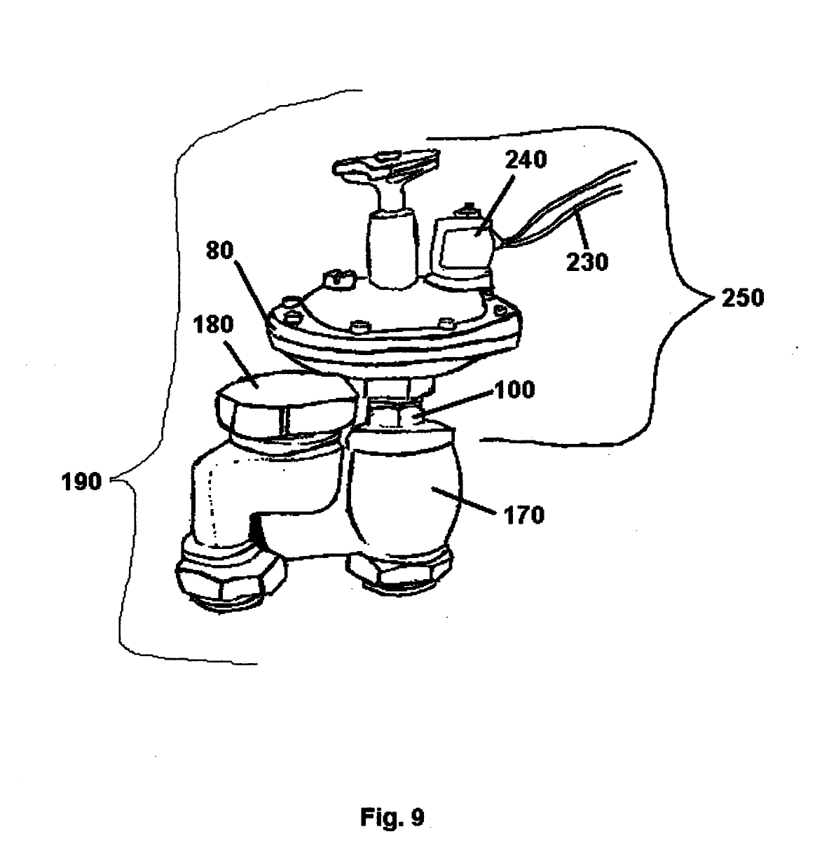

The Actuator Tool 111 is used to remove a circular or saucer-shaped or disc-shaped actuator 250 from an irrigation valve body 170 best seen in FIG. 9.

Step 1 is to turn off the water supply.

Step 2 is to disconnect the control wires 230 attached to the solenoid 240. The solenoid 240 may be removed, but it is not necessary.

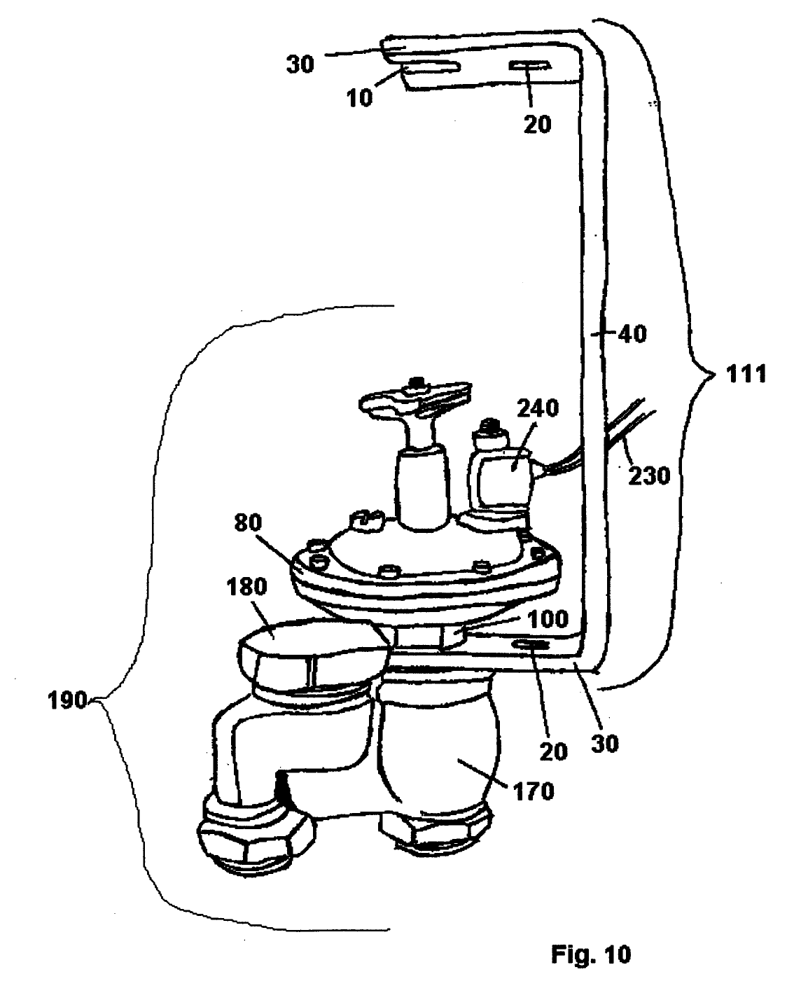

Step 3 is to remove the anti-siphon/backflow valve cover 180 best viewed in FIGS. 9 and 10, by unscrewing in a counterclockwise direction in most cases this is necessary because the cover 180 prevents the actuator 250 from being unscrewed all the way.

Step 4 is to slide the small jaw 10 of the Actuator Tool 111 onto the hexagonal square or similar shaped said grip point 100 best seen in FIG. 10 with the large end up. If the small side will not fit, flip the tool over with the larger side down. In some cases due to various irregularities casting and/or molding residues and/or embossed reference markings 120 best seen in FIG. 2, both jaws 10 of the Actuator Tool 111 FIG. 1 must be used alternately.

Step 5 is to attach a handle to the device such as a ½″ breaker bar 140 FIG. 5 or similar device, a pipe wrench 160 FIG. 7 or a ½″ steel pipe bar or similar device 62 FIG. 8. Torque is applied about the axis in a counterclockwise direction until the actuator is loose enough to be turned by hand.

Step 6 is to remove the Actuator Tool 111.

Step 7 is to continue turning the actuator by hand in a counterclockwise direction until the actuator 250 is free.

Step 8 is to remove the actuator from the valve body 170 FIGS. 9 and 10 by lifting it straight up.

Step 9 is to repair the actuator and reinstall or install a new actuator onto the irrigation valve body 170 by following steps 1-8 in reverse order and axis direction.

### An Alternative Use

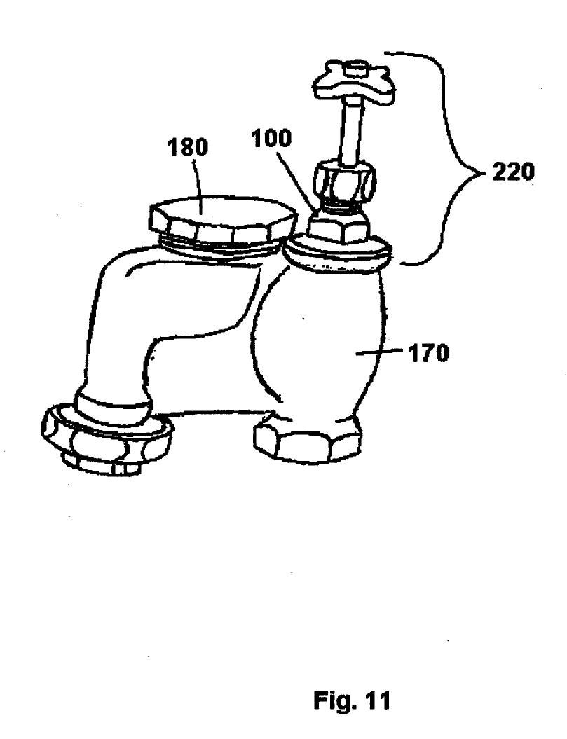

The Actuator Tool 111 may also be used to remove and install a manual irrigation valve stem 220 FIG. 11 in much the same way.

Step 1 is to turn off the water supply.

Step 2 is to remove the anti-siphon/backflow valve cover 180 by unscrewing it in a counterclockwise direction. In most cases this is necessary because the cover prevents the manual valve stem 220 from being unscrewed all the way.

Step 3 is to slide the small jaw 10 of the Actuator Tool onto the square or similar shaped grip point 100 FIG. 11 of the manual valve stem 220 best seen in FIG. 11 with the large jaw 10 up. If the small jaw 10 will not fit, flip the tool over with the larger jaw 10 FIG. 10 down. In some cases due to various irregularities, casting and/or molding residues both jaws 10 of the Actuator Tool 111 FIG. 1 must be used alternately.

Step 4 is to attach a handle to the Actuator Tool 111 such as a “A” breaker bar 140 FIG. 5 or similar device, a pipe wrench 160 FIG. 7, or a ½″ steel pipe or bar 62 FIG. 8 or similar device. Torque is applied in a counterclockwise direction about the axis until the manual valve stem 220 FIG. 11 is loose enough to be turned by hand.

Step 5 is to remove the Actuator Tool 111.

Step 6 is to continue turning the manual valve stem 220 by hand in a counterclockwise direction until the manual valve stem 220 is free.

Step 7 is to remove the manual valve stem 220 from the valve body 170 by lifting it straight up.

Step 8 is to repair the manual valve stem and reinstall or install a new manual valve stem 220 onto the irrigation valve body 170 by following steps 1-7 in reverse order and axis direction.

1. I claim the embodiments of the invention in which an exclusive property or privilege is claimed are defined as follows: the Actuator Tool is a plumbing and/or irrigation tool designed for the easy and convenient removal of saucer-shaped irrigation water flow control devices commonly called irrigation actuators, these devices may go by other names such as: irrigation actuators, automatic adaptor, irrigation timer adaptor, irrigation electric adaptor and so on, these saucer-shaped devices are part of an irrigation valve assembly; the Actuator Tool is designed for the purpose of removing said saucer-shaped irrigation actuators by circumventing the said actuator's saucer-shaped diaphragm housing in order to easily access the irrigation actuator's hexagonal square or similarly shaped said grip point,
in its preferred configuration, the Actuator Tool has a “U” shaped steel body comprised of two offset standard, metric and/or uniquely sized jaws, one on each end
with adjacent ½″ square holes that accommodate a ½″ ratchet drive or ½″ breaker bar for a handle
with the two ends joined by a perpendicular steel bar
with two flat surface areas to accommodate a pipe wrench as a handle
and one 0.85 hole centrally located to accommodate the use of a standard piece of ½″ galvanized steel pipe for a handle.

2. The Actuator Tool of claim 1 is the only tool designed specifically to remove irrigation said actuators.

3. The Actuator Tool of claim 1 uses standard sizes fixed jaws as defined by the Society of Automotive Engineers, and or uniquely sized jaws that are neither standard as defined by the Society of Automotive Engineers such as ½″, 9/16″, ⅞″, etc., or metric sizes such as 10 mm, 11 mm, 12 mm, etc. these uniquely sized fixed jaws such as 0.940″ grip the said actuators' said grip points that are irregularly shaped due to the actuators' manufacturing processes such as brass casting and or embossed markings.

4. The Actuator Tool of claim 1 incorporates into its design the ability to use a common piece of galvanized pipe as a handle which is a cost saving and space saving option for the user of the tool as well as a means of applying a large amount of torque to aid in loosening a stuck said actuator.

5. The Actuator Tool of claim 1 also incorporates the ability to use a pipe wrench as a handle which also is a cost-saving and space-saving option for the user of the Actuator Tool, or more convenient if they have no access to the other handle attachment options.
